(19) United States
(12) Patent Application Publication
(10) Pub. No.: US 2018/0285853 A1
(43) Pub. Date: Oct. 4, 2018

(54) MERCHANT SPLIT TENDER SYSTEMS AND METHODS

(71) Applicant: WALMART APOLLO, LLC, Bentonville, AR (US)

(72) Inventors: Bradley Joseph Kieffer, Rogers, AR (US); Mark Matthews, Rogers, AR (US); Charles David Berry, Fayetteville, AR (US); Prasanna Rajendran, Bentonville, AR (US); David Martin Nelms, Rogers, AR (US); Eytan Daniyalzade, San Francisco, CA (US); Daniel Eckert, Rogers, AR (US)

(21) Appl. No.: 15/767,491

(22) PCT Filed: Oct. 12, 2015
(86) PCT No.: PCT/US15/55136

§ 371 Date: Apr. 11, 2018

(51) Int. Cl. G06Q 20/22; G06Q 20/24; G06Q 20/26; G06Q 20/40

(52) U.S. Cl. CPC G06Q 20/227; G06Q 20/401; G06Q 20/26; G06Q 20/24

(57) ABSTRACT

Provided is a merchant split tender system and method. A cashier completes a scan of merchandise and enters tendering phase. The point of sale sends a the request to authorize a total dollar amount to a wallet processor. The wallet processor accesses a customer payment profile to determine if there is a split tender configuration. If there is a split tender configuration, the wallet processor determines a first account and a second account to use for providing tender for the purchase. The first account and the second account to use is determined by the customer payment profile. The first account may be authorized first and then the second account may be authorized for the remaining amount. The system may also use more than two accounts. This process happens automatically based on the customer payment profile.

### FIELD OF THE INVENTION

The invention relates generally to payment in a store, and more specifically, to systems and methods for splitting payment between multiple payment instruments.

### BACKGROUND

Merchant point of sale systems require customers desiring to pay for purchases with multiple tenders to process each tender individually. This requires multiple steps for both the merchant and the customer. For example, a customer paying for a purchase with a merchant gift card and debit card must first tell the merchant the amount they desire to be deducted from each tender and swipe/dip each tender after the merchant enters the amount to be deducted. Additionally, the merchant must manually key in the value to be deducted and pick the correct tender button on the merchant point of sale system.

### BRIEF SUMMARY

In one aspect, provided is a method for splitting tender at point of sale using a mobile pay system. The method comprises: completing scan of merchandise and entering tendering phase; sending a the request to authorize a total dollar amount to a wallet processor, wherein the wallet processor accesses a customer payment profile to determine if there is a split tender configuration; and determining a first account and a second account to use for providing tender for the purchase, wherein the first account and the second account to use is determined by the customer payment profile and preferences.

In another aspect, provided is a merchant split tender system comprising: a point of sales; a mobile device having a mobile application; and a wallet processor in communication with the mobile device and the point of sale wherein the wallet processor accesses a customer payment profile to determine if there is a split tender configuration in response to receiving an authorization request for a total dollar amount from the point of sale, and wherein the wallet processor splits the amount due between at least two accounts in accordance with the customer payment profile.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a system for re-using e-commerce payment instruments for in-store purchasing, in accordance with embodiments.

FIG. 2 is a flow diagram illustrating a method for creating an e-commerce account, in accordance with some embodiments.

FIG. 3 is a flow diagram illustrating a method for setting up e-commerce payments instruments for use in-store, in accordance with some embodiments.

FIG. 4 is an illustrative view of a merchant split tender system, in accordance with some embodiments.

FIG. 5 is a flow diagram illustrating a method for setting up a customer wallet to be used in a merchant split tender system, in accordance with some embodiments.

FIG. 6 is a flow diagram illustrating a method for using a merchant split tender system, in accordance with some embodiments.

### DETAILED DESCRIPTION

Many store customers have times when they shop online and other times when they are physically present at a brick-and-mortar store. In order to shop online, a customer must establish an e-commerce account with the particular business which often includes entering and storing payment instruments in a database for use with the that particular business. This provides ease of checking out at the end of an online shopping session, wherein the customer can simply execute a few mouse clicks or other input, such as use of a touchscreen and the like, to execute payment to complete an online transaction. Sometimes the payment instruments are stored for future re-use as part of checking out and completing an order.

Shopping in a brick-and-mortar store requires the customer must move around and peruse items and goods with the store, select the goods, often putting them within a cart and then proceeding to a checkout line, where a point of sale terminal is then used to scan or otherwise total the amount of money due to purchase the items. The customer must then retrieve the payment instrument from his or her wallet or purse and provide the payment instrument to the point of sale terminal. If a payment card is the type of payment instrument, the card is either swiped by the customer or the employee at the checkout and the payment is processed either by entering a personal identification number (“PIN”) or signing to authorize the payment, thus completing the transaction.

Additionally, it requires several steps in order to split the payment for a purchase between multiple payment instruments. The present inventive concepts provide a system and methods to improve a merchant's check out experience allowing customers and merchants an easy and quick solution to process purchases that include multiple payment cards. The improvement may include creation of an online ‘wallet’ where customers can store multiple payment cards. The customer would create preferences in their ‘wallet’ as to how they prefer a merchant to tender their transactions. Customers will be able to change their preferences prior to tendering their purchase at the merchant. When the online ‘wallet’ is presented the merchant will systemically ‘walk the wallet’ based on customer preferences and available balances in the applicable payment card. For example, a customer paying with merchant gift card(s) and debit card will be able to set preferences in the wallet to first deplete the merchant gift card(s) and then pay remainder with their debit card. The customer no longer has to process multiple swipes of payment cards and the merchant doesn't have to manually key in the amounts and choose the correct tender type multiple times.

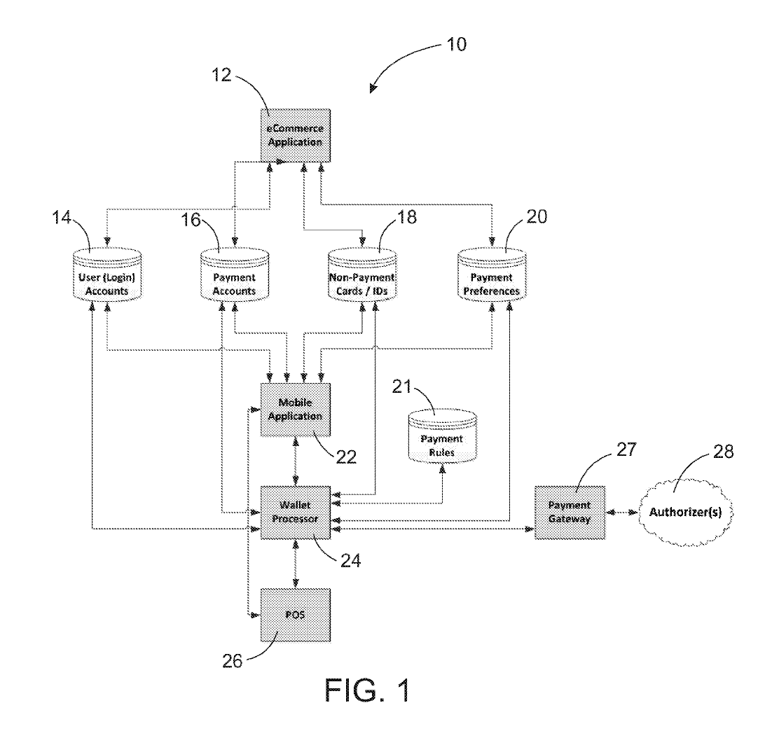

FIG. 1 is a block diagram of a system 10 for re-using e-commerce payment instruments for in-store purchasing. The system 10 may include a backend system having various databases, such as, but not limited to user accounts 14, payment accounts 16, non-payment cards/identifiers 18, payment preferences 20, and payment rules 21. These databases 14, 16, 18 and 20 are accessible from an e-commerce application 12. Further, the databases 14, 16, 18 and 20 are accessible from a mobile application 22. The system 10 may also include a wallet processor 24, a point of sale (“POS”) 26, a payment gateway 27 and an authorizer(s) 28. The wallet processor 24 may have access to payments accounts 16, non-payment cards/identifiers 18, payment preferences 20, and payment rules 21 databases. The e-commerce application 12 may be accessible through a computing device, such as but not limited to a computer, a laptop, a tablet, a smartphone and the like. The e-commerce application 12 may be an e-commerce website accessible through an Internet connection. The mobile application 22 may be accessible through a mobile device, such as a smartphone, a tablet and the like. The mobile application 22 may be a downloadable application that is installed and operated on the mobile device. The payment gateway 27 may operate to send messages routed to the authorizers 28.

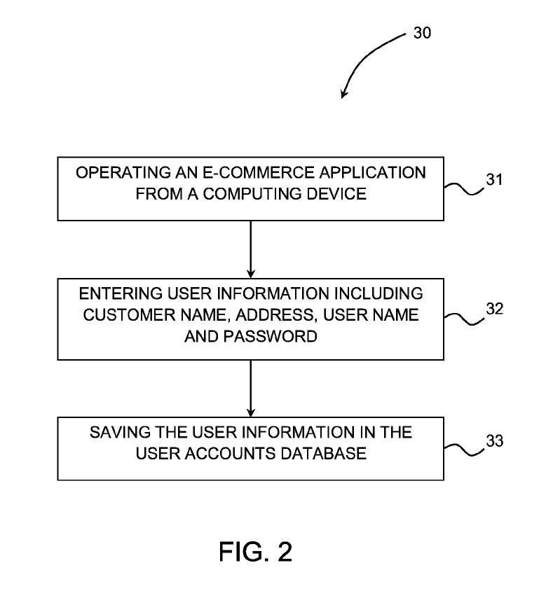

Referring additionally to FIG. 2, the system 10 may be utilized to execute a method 30 of creating an e-commerce account. The method 30 may include operating an e-commerce application 12 from a computing device (Step 31); entering user information including customer name, address, user name and password (Step 32); and saving the user information in the user accounts 14 database (Step 33). The method 30 may further include entering a payment instrument information through the e-commerce application 45 and storing the payment instrument information in the payment accounts 16 database. The method 30 may also include entering non-payment card/identifier information through the e-commerce application 12 and storing the non-payment card/identifier information in the non-payment cards/identifier 18 database. It will be understood that the method 30, in some embodiments, is a precondition to using the system to complete a transaction at a POS 26.

Further, access to the user accounts 14, payment accounts 16, non-payment cards/identifiers 18 and payment preferences 20 databases are secured by restricting access to the information. The username and password stored in the user accounts 14 database includes the information that must be input through a user graphical interface in order for a customer to login to his or her e-commerce account to access, update, change and the like the information stored in the user accounts 14, payment accounts 16, non-payment cards/identifiers 18, and payment preferences 20 databases. The customer may login to the e-commerce account through the e-commerce application 12 or through the mobile application 22.

It is anticipated that the user account 14 may be changed and updated at any time through use of the e-commerce application 12 or the mobile application 22. For example, address information may be updated, additional payment instruments may be added to the payment accounts 16, and additional non-payment cards may be added to the non-payment cards/identifier 18. Further, as payment instruments expire, the payment instrument information stored in the payment accounts 16 may be updated or removed.

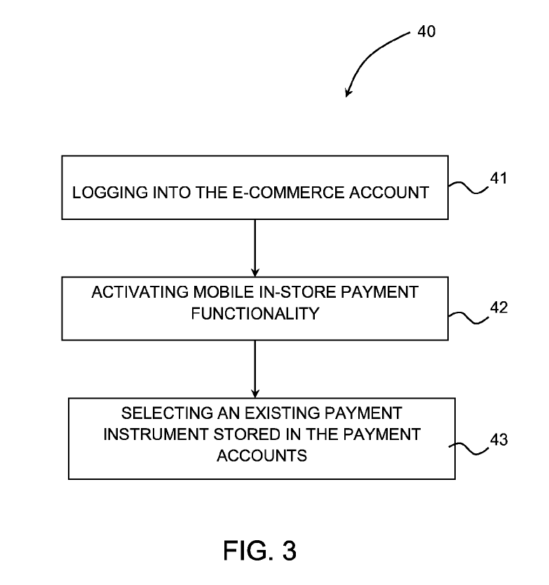

FIG. 3 depicts a method 40 of setting up e-commerce payments instruments for in-store use. For example, the method 40 may include logging into the e-commerce account (Step 41) through the mobile application 22 or through the e-commerce application 12;

activating mobile in-store payment functionality (Step 42), wherein activating the mobile in-store payment functionality requires creating a new payment authentication code, such as a PIN, password and the like; and selecting an existing payment instrument stored in the payment accounts 16 for use in mobile in-store payment (Step 43). This information may be stored in the payment preferences 20.

Step 43 of selecting an existing payment instrument may be repeated to select multiple payment instruments for use with mobile in-store payments. If multiple payment instruments are selected, the customer may also indicate how he or she prefers to use the payment instruments when conducting transactions in the store.

The method 40 may also include entering a new payment instrument through the mobile application 22 and indicating if it may also be used for e-commerce transactions and/or how the customer prefers to use the payment instrument when transacting in the store.

The method 40 may also include presenting a list of existing non-Payment cards/identifiers (e.g. Membership, Loyalty, Discount, Offers) to a customer and selecting which non-payment cards/identifiers to load for mobile in-store processing. This may be repeated if there are multiple non-payment cards on file. The method may also include entering new non-Payment cards/identifiers to the non-payment cards/identifiers 18 database and selecting it to be used for e-commerce transactions or when transacting in the store.

Current merchant point of sale solutions only allows one tender at a time even when the customer is paying for one purchase. This leads to increased time at the merchant point of sale for the customer and the cashier. The present invention will create a systemic solution providing customer and cashiers a simple solution for processing transactions that require split tendering. This invention creates the ability for customers to utilize an online ‘wallet’ where they can store multiple payment cards. The customer may create preferences in their ‘wallet’ as to how they prefer a merchant to tender their transactions. Customers will be able to change their preferences prior to tendering their purchase at the merchant. When the online ‘wallet’ is presented the merchant will systemically ‘walk the wallet’ based on customer preferences and available balances in the applicable payment card. This improvement will remove steps in the checkout process providing a faster and easier way for merchants and customers to accommodate purchases with multiple payment cards.

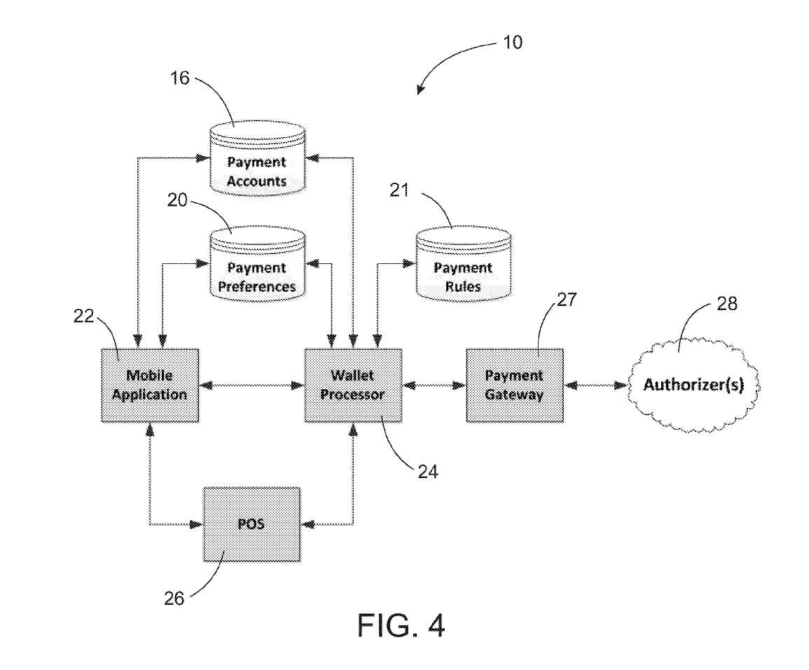

FIG. 4 depicts a merchant split tender system 110 in accordance with embodiments. The system 110 includes a point of sales (“POS”) 26, a mobile application 22 operating a mobile device of a customer, a wallet processor 24, a payment preferences 20 database, a payment rules database 21, a payment accounts 16 database and authorizers 28. A customer may check-in using his or her mobile device and operate the mobile application 22 associate the customer's payment profile with the POS 26. Once the cashier completes scanning merchandise at the POS 26, the check process enters a tendering phase.

The check-in process indicates that the customer has opted to pay using the payment feature of a mobile, online wallet, the cashier may indicate on the POS 26 to use that tender mechanism. The POS 26 sends the request to authorize a specific dollar amount to the wallet processor 24. The wallet processor 24 accesses the customer's preferences or customer's payment profile stored in the payment preferences 20 database, the payment accounts 16 database, and the payment rules database 21. The customer has accessed his or her payment profile prior to check-in in order to select split tender payment. The wallet processor 24 determines and accesses the first account to use in accordance with the customer's payment profile and payment rules 21. The wallet processor 24 creates an authorization and sends it for the full amount of the transaction to the authorizers 28.

If the authorization response does NOT satisfy the amount requested (e.g. partial authorization, host unavailable, etc.), the wallet processor 24 automatically checks customer preferences and payment rules to see if there is another account to use and loop back to determine and access the next account to use in accordance with the customer's payment profile. If the authorization response satisfies the amount requested, the wallet processor 24 does not need to perform a loop to obtain full payment.

The wallet processor 24 sends the collection of authorization responses to the POS 26. The POS 26 completes the transaction and alerts the wallet processor 24, which notifies the mobile application 22. In this way, the customer does not need to manual run multiple payment instruments, thereby improving speed overall experience.

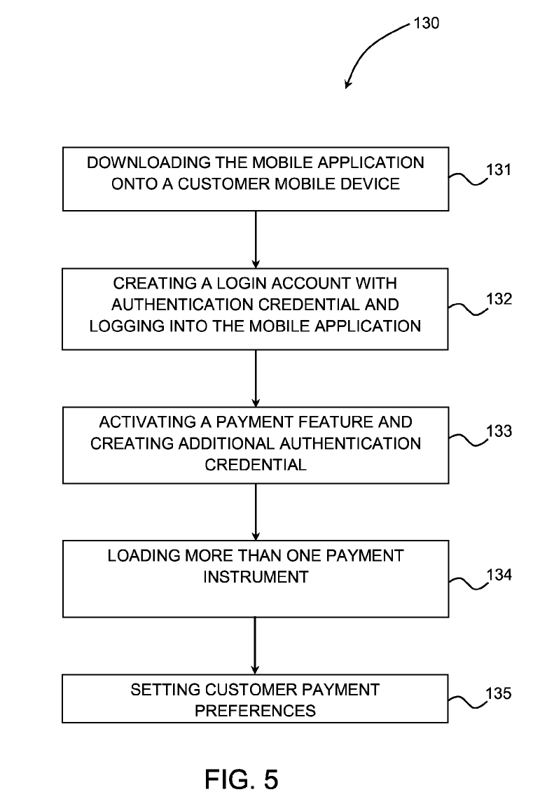

Prior to using the merchant split tender system 110, a method 130 for setting up a customer wallet to be used in a merchant split tender system, is shown in FIG. 5 in accordance with embodiments. The method 130 may include downloading the mobile application 22 onto a customer mobile device (Step 131); creating a login account with authentication credential by the customer, and logging into the mobile application (Step 132); activating a payment feature and creating additional authentication credential (Step 133); loading more than one payment instrument (Step 134); and setting customer payment preferences (Step 135). Setting the customer payment preferences may include to use the split tender functionality. Using split tender functionality may require the customer to indicate to use gift cards (and optionally indicate order or processing) and a bank card/payment account (e.g. credit, debit, checking).

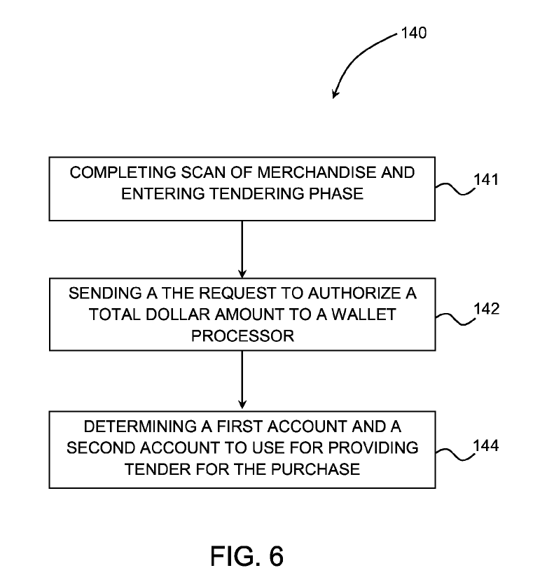

After establishing wallet to be used in the merchant split tender system 110, the system 110 may operate. FIG. 6 depicts a method 140 for splitting tender at point of sale using a mobile pay system in accordance with embodiments. The method 140 may include completing scan of merchandise and entering tendering phase (Step 141); sending a the request to authorize a total dollar amount to a wallet processor, wherein the wallet processor accesses a customer payment profile to determine if there is a split tender configuration (Step 142); and determining a first account and a second account to use for providing tender for the purchase, wherein the first account and the second account to use is determined by the customer payment profile (Step 143) and payment rules.

The method 140 may further comprise creating an authorization by the wallet processor for an amount due at the point of sale for the first account; authorizing a first dollar amount to be paid with the first account, wherein the first dollar amount is less than the total dollar amount; and creating a second authorization for the second account for a second dollar amount due at the point of sale, wherein the second dollar amount is equal to the total dollar amount minus the first dollar amount. The method 140 may also include sending a collection of authorization responses to the point of sale. After sending a collection of authorization responses to the point of sale, the method 140 may include completing the transaction and alerting the wallet processor.

It should be understood that the first account may be a gift card. Further, the second account may be a bank card. While it is discussed that one payment instrument is a gift card and another is a bank card, it will be understood that both can be gift cards or both can be bank cards. Additionally, the customer payment profile may include more than two payment instruments to use to spilt tender at the point of sale. Additionally, it should be understood that while two accounts are shown in FIG. 6, that more than two account may be utilized for splitting the tender, such as, but not limited to 3, 4, 5 or more. Further, the payment instruments may be any combination of gift cards, bank cards and payment accounts.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), solid-state drives (SSD), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C-HE or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a wireless network, a cellular data network, a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method for splitting tender at point of sale using a mobile pay system, the method comprising:
completing scan of merchandise and entering tendering phase;
sending a the request to authorize a total dollar amount to a wallet processor, wherein the wallet processor accesses a customer payment profile to determine if there is a split tender configuration; and
determining a first account and a second account to use for providing tender for the purchase, wherein the first account and the second account to use is determined by the customer payment profile and payment rules.

2. The method of claim 1, further comprising creating an authorization by the wallet processor for an amount due at the point of sale for the first account.

3. The method of claim 2, further comprising authorizing a first dollar amount to be paid with the first account, wherein the first dollar amount is less than the total dollar amount.

4. The method of claim 2, further comprising creating a second authorization for the second account for a second dollar amount due at the point of sale, wherein the second dollar amount is equal to the total dollar amount minus the first dollar amount.

5. The method of claim 3, further comprising sending a collection of authorization responses to the point of sale.

6. The method of claim 1, further comprising completing the transaction an alerting the wallet processor.

7. The method of claim 1, wherein the first account is a gift card.

8. The method of claim 1, wherein the first account is a bank card.

9. The method of claim 1, wherein the second account is a gift card.

10. The method of claim 1, wherein the second account is a bank card.

11. A merchant split tender system comprising:
a point of sales;
a mobile device having a mobile application; and
a wallet processor in communication with the mobile device and the point of sale wherein the wallet processor accesses a customer payment profile to determine if there is a split tender configuration in response to receiving an authorization request for a total dollar amount from the point of sale, and wherein the wallet processor splits the amount due between at least two accounts in accordance with the customer payment profile.

12. The system of claim 11, further comprising a payment accounts database, wherein the payment accounts database stores payment instruments of the customer.

13. The system of claim 12, further comprising a payment preferences database for storing customer payment preferences.

14. The system of claim 13, wherein the customer payment profile comprises data from the payment accounts database and the payment preferences database.

15. The system of claim 11, further comprising an authorizer for authorizing payment from the at least two accounts.

16. The system of claim 11, wherein a first of the at least two accounts is a gift card.

17. The system of claim 16, wherein a second of the at least two account is a gift card.

18. The system of claim 16, wherein a second of the at least two accounts is a bank card.

19. The system of claim 11, wherein a first of the at least two accounts is a bank card.

20. The system of claim 19, wherein a second of the at least two account is a gift card.

21. The system of claim 19, wherein a second of the at least two accounts is a bank card.
